(19) United States
(12) Patent Application Publication
(10) Pub. No.: US 2005/0216557 A1
(43) Pub. Date: Sep. 29, 2005

(54) Program, computer, and data processing method

(76) Inventors: Tsunayuki Ohwa, Tokyo (JP); Kosuke Yoshitomi, Kanagawa (JP); Yusuke Kudo, Tokyo (JP)

Correspondence Address: William E. Vaughan;Bell, Boyd & Lloyd LLC, P.O. Box 1135, Chicago, IL, 60690, US

(21) Appl. No.: 11/084,312

(22) Filed: Mar. 18, 2005

(30) Foreign Application Priority Data
Mar. 25, 2004 (JP) P2004-088173

(51) Int. Cl. G06F 15/16; G06F 17/30

(52) U.S. Cl. 709/204; 709/202; 707/1

(57) ABSTRACT

A program, a computer, and a data processing method used in a field of data communication are provided. The program is provided for making a computer perform determining a place where users of a plurality of computers are to meet on a basis of index data serving as indexes for identifying positions of the plurality of computers; transmitting data indicating the place.

### CROSS REFERENCE TO RELATED APPLICATIONS

The present invention claims priority to Japanese Patent Document No. P2004-088173 filed on Mar. 25, 2004, the disclosure of which is herein incorporated by reference.

### BACKGROUND OF THE INVENTION

The present invention relates to a program, a computer, and a data processing method used in a field of data communication.

With the recent spread of portable type terminal apparatuses such as portable telephones and the like, there are cases where a plurality of users communicate with each other by call or electronic mail using a terminal apparatus to determine a meeting place while the users are out.

Conventionally, for example, one user inquires of a plurality of other users about present positions of the other users by call or electronic mail, determines an appropriate meeting place from a viewpoint of required times or the like on the basis of the obtained present positions, and notifies the result to the other users by call or electronic mail.

However, the conventional method described above has a problem of a heavy burden on the user who determines and notifies the meeting place.

### SUMMARY OF THE INVENTION

The present invention relates to a program, a computer, and a data processing method used in a field of data communication. In an embodiment, the present invention provides a program, a computer, and a data processing method that can reduce a burden on a user involved in determining a meeting place where users of a plurality of computers arrange to meet.

According to an embodiment, there is provided a program for making a computer perform: a first step of determining a place where users of a plurality of computers are to meet on a basis of index data serving as indexes for identifying positions of the plurality of computers; and a second step of transmitting data indicating the place determined in the first step to the computers.

Effects of the program according to an embodiment are as follows.

A computer executes the program according to an embodiment.

According to the program, the computer performs a first step of determining a place where users of a plurality of computers are to meet on a basis of index data serving as indexes for identifying positions of the plurality of computers.

Next, according to the program, the computer performs a second step of transmitting data indicating the place determined in the first step to the computers.

According to an embodiment, there is provided a computer including a memory for storing a program, an interface, and an executing circuit. The executing circuit reads and executes the program from the memory, and according to the program, the executing circuit determines a place where users of a plurality of computers are to meet on a basis of index data serving as indexes for identifying positions of the plurality of computers and transmits data indicating the determined place to the computers via the interface.

Effects of the computer according to another embodiment are as follows.

First, the executing circuit reads and executes the program from the memory. According to the program, the executing circuit determines a place where users of a plurality of computers are to meet on a basis of index data serving as indexes for identifying positions of the plurality of computers.

Next, according to the program, the executing circuit transmits data indicating the determined place to the computers via the interface.

According to an embodiment, there is provided a data processing method performed by a computer. The data processing method includes: a first step of determining a place where users of a plurality of computers are to meet on a basis of index data serving as indexes for identifying positions of the plurality of computers; and a second step of transmitting data indicating the place determined in the first step to the computers.

Effects of the data processing method according to an embodiment are as follows.

In the first step, a computer determines a place where users of a plurality of computers are to meet on a basis of index data serving as indexes for identifying positions of the plurality of computers.

In the second step, the computer transmits data indicating the place determined in the first step to the computers.

As described above, according to the present invention, it is possible to provide a program, a computer, and a data processing method that can reduce a burden on a user when users of a plurality of computers arrange to meet.

Additional features and advantages of the present invention are described in, and will be apparent from, the following Detailed Description of the Invention and the figures.

### BRIEF DESCRIPTION OF THE FIGURES

FIG. 1 is a diagram of general configuration of a communication system according to an embodiment of the present invention;

FIG. 2 is a diagram of an external appearance of a front side of a terminal apparatus shown in FIG. 1;

FIG. 3 is a functional block diagram of the terminal apparatus shown in FIG. 1;

FIG. 4 is a diagram of assistance in explaining programs stored in a memory shown in FIG. 3;

FIG. 5 is a diagram of assistance in explaining functional modules implemented by a CPU shown in FIG. 3 by executing the programs shown in FIG. 4;

FIG. 6 is a diagram of assistance in explaining the format of an electronic mail used in the embodiment of the present invention;

FIG. 7 is a flowchart of assistance in explaining an example of operation of the terminal apparatus shown in FIG. 1 when the terminal apparatus passes an automatic ticket gate installed in a train station;

FIG. 8 is a flowchart of assistance in explaining an example of operation when a user of the terminal apparatus shown in FIG. 1 inquires present positions of users of other terminal apparatuses;

FIG. 9 is a diagram of assistance in explaining a GUI screen used in a process shown in FIG. 8;

FIG. 10 is a flowchart of assistance in explaining an example of operation performed by the terminal apparatus receiving a present position inquiry electronic mail transmitted by the procedure shown in FIG. 8;

FIG. 11 is a diagram of assistance in explaining a GUI screen used in a process shown in FIG. 10;

FIG. 12 is a flowchart of assistance in explaining an example of operation performed by the terminal apparatus receiving a present position reply electronic mail transmitted by the procedure shown in FIG. 10;

FIG. 13 is a diagram of assistance in explaining a GUI screen used in a process shown in FIG. 12;

FIG. 14 is a flowchart of assistance in explaining a concrete example of a process in step ST34 shown in FIG. 12, that is, a process of generating meeting place data and latest arrival time data;

FIG. 15 is a diagram of assistance in explaining the process shown in FIG. 14;

FIG. 16 is a flowchart of step ST34 in FIG. 12 in a second embodiment of the present invention;

FIG. 17 is a diagram of assistance in explaining the process shown in FIG. 16;

FIG. 18 is a flowchart of step ST34 in FIG. 12 in a third embodiment of the present invention;

FIG. 19 is a diagram of assistance in explaining a GUI screen used in a fourth embodiment of the present invention;

FIGS. 20A and 20B are diagrams of assistance in explaining a GUI screen used in a fifth embodiment of the present invention; and

FIG. 21 is a functional block diagram of a terminal apparatus according to a sixth embodiment of the present invention.

### DETAILED DESCRIPTION OF THE INVENTION

The present invention relates to a program, a computer, and a data processing method used in a field of data communication. In an embodiment, the present invention provides a program, a computer, and a data processing method that can reduce a burden on a user involved in determining a meeting place where users of a plurality of computers arrange to meet. A communication system according to an embodiment of the present invention will hereinafter be described.

### First Embodiment

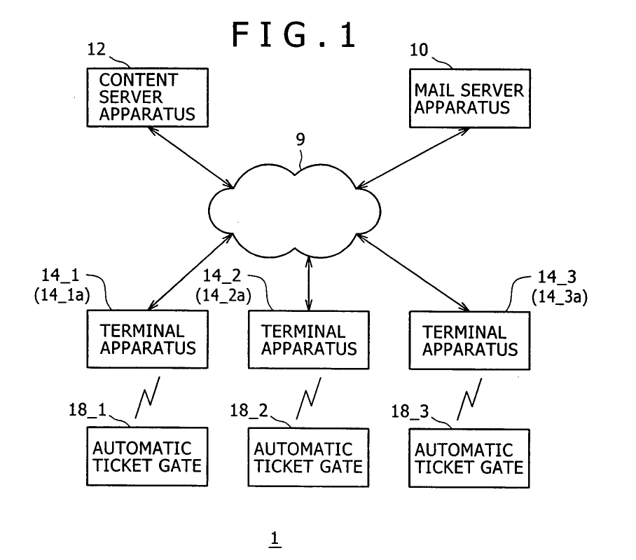

A first embodiment of the present invention will hereinafter be described with reference to FIGS. 1 to 15.

Correspondences between elements of the first embodiment and elements of the present invention will first be described.

Terminal apparatuses 14_1 to 14_3 shown in FIG. 1 and the like correspond to a computer according to the present invention.

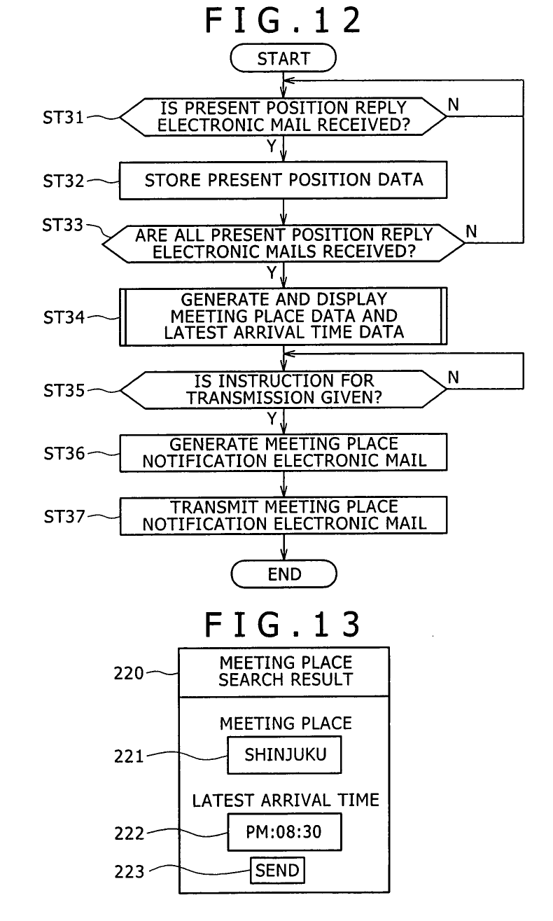

Step ST34 shown in FIG. 12 corresponds to a first step of a first invention and a first step of a third invention.

Step ST37 shown in FIG. 12 corresponds to a second step of the first invention and a second step of the third invention.

A procedure shown in FIG. 8 corresponds to a third step of the first invention.

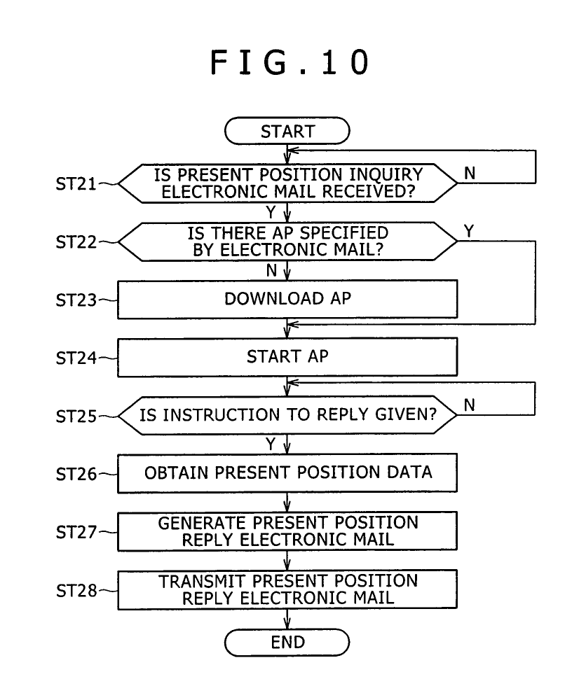

A procedure shown in FIG. 10 corresponds to a fourth step of the first invention.

Present position data of the first embodiment corresponds to index data of the present invention.

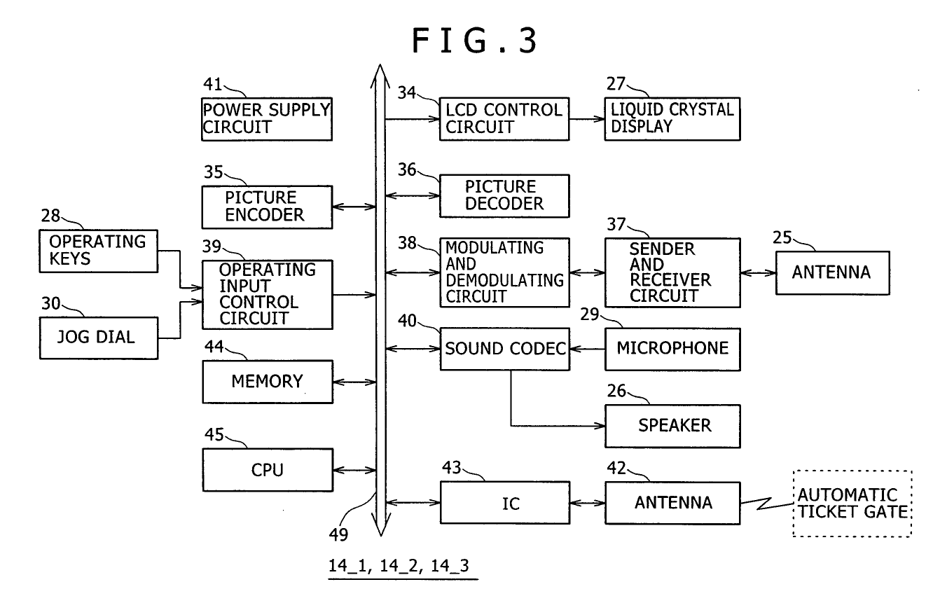

A sender and receiver circuit 37 and an antenna 25 shown in FIG. 3 correspond to an interface of a second invention. A memory 44 corresponds to a memory of the second invention. A CPU 45 corresponds to an executing circuit of the second invention.

An IC 43 shown in FIG. 3 corresponds to an integrated circuit of the second invention.

FIG. 1 is a diagram of general configuration of a communication system 1 according to an embodiment of the present invention.

As shown in FIG. 1, the communication system 1 has for example a mail server apparatus 10, a content server apparatus 12, and terminal apparatuses 14_1, 14_2, and 14_3.

The mail server apparatus 10, the content server apparatus 12, and the terminal apparatuses 14_1, 14_2, and 14_3 communicate via a network 9.

While the three terminal apparatuses 14_1, 14_2, and 14_3 are used in the communication system 1 shown in FIG. 1, the number of terminal apparatuses is arbitrary as long as there is a plurality of terminal apparatuses.

The number of mail server apparatus 10 and the number of content server apparatus 12 are also an arbitrary number of one or more.

Incidentally, in the first embodiment, all communications between the mail server apparatus 10, the content server apparatus 12, and the terminal apparatuses 14_1, 14_2, and 14_3 are performed via the network 9.

An outline of the communication system 1 will be described in the following.

In the communication system 1 shown in FIG. 1, the terminal apparatus 14_1, for example, receives electronic mails including present position data from the terminal apparatuses 14_2 and 14_3, and determines a meeting place where users of the terminal apparatuses 14_1, 14_2, and 14_3 will meet on the basis of the received present position data and present position data of the terminal apparatus 14_1 itself. Then, the terminal apparatus 14_1 transmits an electronic mail indicating the determined meeting place to the terminal apparatuses 14_2 and 14_3.

Specifically, the terminal apparatus 14_1 determines the meeting place on the basis of the received electronic mails and on the basis of times required for arrival of the users of the terminal apparatuses 14_1 to 14_3.

In the first embodiment, the terminal apparatuses 14_1 to 14_3 obtain present position data indicating present positions of the terminal apparatuses 14_1 to 14_3 when passing automatic ticket gates 18_1 to 18_3 on the basis of positions of the automatic ticket gates.

[Mail Server Apparatus 10]

The mail server apparatus 10 receives electronic mails from the terminal apparatuses 14_1, 14_2, and 14_3, and transmits the electronic mails to the terminal apparatuses 14_1, 14_2, and 14_3 corresponding to destination addresses shown within the electronic mails.

Incidentally, in addition to the above-described method of using electronic mails using the mail server apparatus 10, a method of sending and receiving data between the terminal apparatuses 14_1, 14_2, and 14_3 may be another method such as an instant messenger, for example.

[Content Server Apparatus 12]

The content server apparatus 12 for example receives a request from the terminal apparatuses 14_1, 14_2, and 14_3, performs a meeting place determining process or the like in response to the request, and then transmits a reply indicating a result of the process to the terminal apparatuses 14_1, 14_2, and 14_3.

[Terminal Apparatuses 14_1, 14_2, and 14_3]

The terminal apparatuses 14_1, 14_2, and 14_3 for example have the same configuration.

The terminal apparatus 14_1 will be described in the following.

The terminal apparatus 14_1 transmits and receives electronic mails to and from the terminal apparatuses 14_2 and 14_3 via the mail server apparatus 10.

Also, the terminal apparatus 14_1 accesses the content server apparatus 12 as required to be provided with predetermined service by the content server apparatus 12.

In addition, for example, when the terminal apparatus 14_1 is situated within a predetermined distance of the automatic ticket gate 18_1 or the like, the terminal apparatus 14_1 performs radio communication with the automatic ticket gate 18_1 or the like in a secure condition, and thereby performs a payment process.

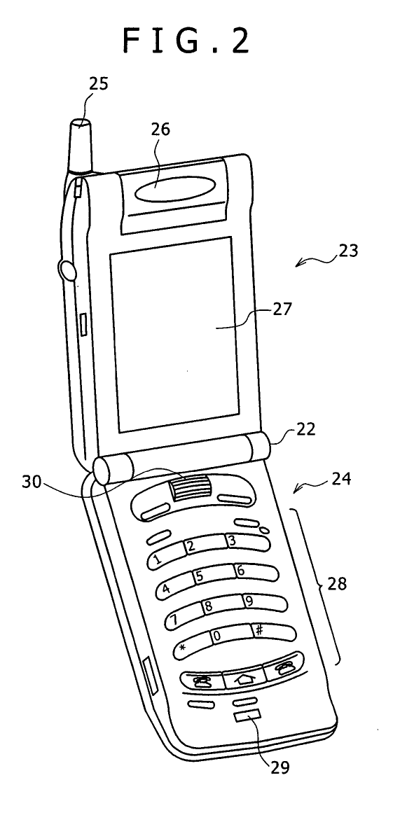

FIG. 2 is a diagram of an external appearance of a front side of the terminal apparatus 14_1 shown in FIG. 1.

As shown in FIG. 2, the terminal apparatus 14_1 is for example a portable telephone. The terminal apparatus 14_1 is divided into a display unit 23 and a main unit 24 by a central hinge part 22. The terminal apparatus 14_1 is formed so as to be foldable via the hinge part 22.

An antenna 25 for transmission and reception is attached to a left part of an upper edge of the display unit 23 so as to be extendable and retractable. Radio waves are transmitted and received to and from a base station not shown in the figure via the antenna 25.

The display unit 23 has a speaker 26 provided to an end part thereof, and a liquid crystal display 27 provided at a center thereof.

The main unit 24 has operating keys 28 provided on a surface thereof, such as number keys “0” to “9,” a call key, a redial key, a call ending and power supply key, a clear key, an electronic mail key, and the like. Various instructions can be inputted by using the operating keys 28.

In addition, the main unit 24 has a microphone 29 provided below the operating keys 28. The microphone 29 collects voice of a user at the time of a call.

Further, the main unit 24 has a rotatable jog dial 30 provided above the operating keys 28 in a state of slightly projecting from the surface of the main unit 24. In response to an operation of rotating the jog dial 30, various operations such as an operation of scrolling a telephone book list or an electronic mail displayed on the liquid crystal display 27, an operation of turning a page of a simplified web site, a picture advance operation, and the like are performed.

Also, when a desired telephone number is selected from a plurality of telephone numbers in an address book displayed on the liquid crystal display 27 in response to an operation by a user of rotating the jog dial 30, and the jog dial 30 is pressed in a direction of an inside of the main unit 24, the selected telephone number is confirmed to perform a process of automatically making a call at the telephone number.

An electronic mail address of each user is registered in the address book. The address is specified as a destination address by using the jog dial 30 at the time of creating an electronic mail.

FIG. 3 is a functional block diagram of the terminal apparatus 14_1 shown in FIG. 1.

As shown in FIG. 3, the terminal apparatus 14_1 includes for example the antenna 25, the speaker 26, the liquid crystal display 27, the operating keys 28, the microphone 29, the jog dial 30, an LCD (Liquid Crystal Display) control circuit 34, a picture encoder 35, a picture decoder 36, a sender and receiver circuit 37, a modulating and demodulating circuit 38, an operating input control circuit 39, a sound codec 40, a power supply circuit 41, an antenna 42, an IC (Integrated Circuit) 43, a memory 44, and a CPU (Central Processing Unit) 45.

Incidentally, in FIG. 3, the elements identified by the same reference numerals as in FIG. 2 are the same as described with reference to FIG. 2.

In the terminal apparatus 14_1, the LCD control circuit 34, the picture encoder 35, the picture decoder 36, the modulating and demodulating circuit 38, the operating input control circuit 39, the sound codec 40, the IC 43, the memory 44, and the CPU 45, for example, are connected to each other via a data line 49.

Under control of the CPU 45, the LCD control circuit 34 for example outputs decoded picture data, which is inputted from the picture decoder 36, to the liquid crystal display 27. Thus, the LCD control circuit 34 outputs an image corresponding to the picture data to the liquid crystal display 27.

The picture encoder 35 for example encodes data of a picture taken by a digital camera not shown in the figure by MPEG4 (Moving Picture Experts Group), MPEG2, or the like, and then writes the encoded picture data to the memory 44. The camera is included in the terminal apparatus 14_1.

Under control of the CPU 45, the picture decoder 36 decodes the picture data encoded by MPEG4, MPEG2, or the like, and then outputs the decoded picture data to the LCD control circuit 34.

The sender and receiver circuit 37 converts an analog signal received by the antenna 25 via a base station into a digital signal, and then outputs the digital signal to the modulating and demodulating circuit 38.

Also, the sender and receiver circuit 37 converts a digital signal input from the modulating and demodulating circuit 38 into an analog signal, and then transmits the analog signal to the base station via the antenna 25.

The modulating and demodulating circuit 38 subjects a signal input from the sender and receiver circuit 37 to a demodulation process such as a spectrum despreading process or the like, and thereby generates data.

Also, under control of the CPU 45, the modulating and demodulating circuit 38 outputs a signal generated by subjecting input data to a modulation process such as spectrum spreading or the like to the sender and receiver circuit 37.

The operating input control circuit 39 outputs an operating signal input from the operating keys 28 and the jog dial 30 to the CPU 45.

The sound codec 40 encodes a sound signal input from the microphone 29.

Also, under control of the CPU 45, the sound codec 40 decodes an input sound signal, and then outputs the sound signal to the speaker 26.

The power supply circuit 41 supplies driving power to each component of the terminal apparatus 14_1.

The antenna 42 for example transmits and receives a signal to and from a radio communication apparatus such as the automatic ticket gate 18_1 shown in FIG. 1 by a non-contact method.

The IC 43 is a tamper-resistant circuit. The IC 43 for example communicates with the automatic ticket gate 18_1 or the like shown in FIG. 1 via the antenna 42 to perform a payment process or the like.

Incidentally, the IC 43 communicates with not only automatic ticket gates but also payment devices installed in stores and the like to perform a payment process.

The tamper-resistant circuit is formed so as to prevent erroneous operation or leakage of internal data when an external attack (an attack of unauthorized reading of internal data or setting of an input frequency or an input voltage to a value outside a specified value) is made on the circuit. Specifically, to prevent the reading of internal data, the tamper-resistant circuit has a multilayer circuit structure in which the memory is disposed in a bottom layer and a dummy layer (for example an aluminum layer) is introduced in an upper and a lower layer, thereby making it difficult to externally access a memory I/F. Also, the tamper-resistant circuit has a frequency detecting circuit and a voltage detecting circuit so that the circuit does not operate when the frequency or the voltage becomes a value outside the specified value.

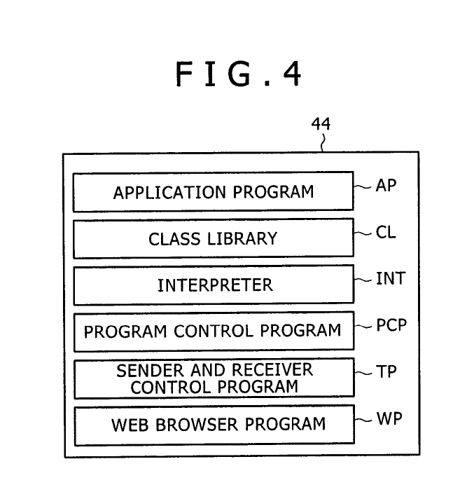

As shown in FIG. 4, the memory 44 stores a web browser program WP, a sender and receiver control program TP, an interpreter INT, a class library CL, and an application program AP.

Also, the memory 44 stores address book data and various data necessary for processing of the CPU 45.

The CPU 45 realizes various functions by executing the programs shown in FIG. 4.

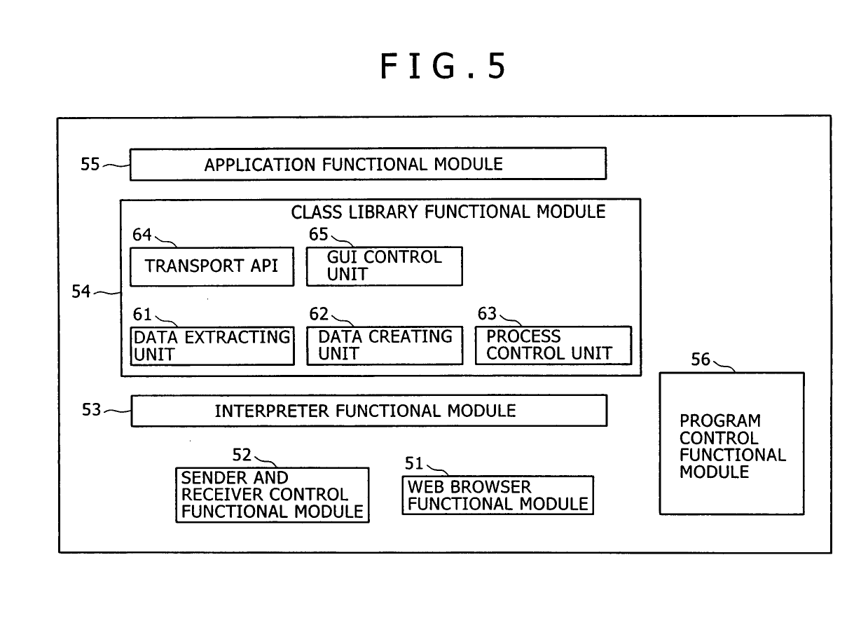

FIG. 5 is a diagram of assistance in explaining functional modules implemented by the CPU 45 shown in FIG. 3 by executing the programs shown in FIG. 4.

As shown in FIG. 5, the CPU 45 implements for example a web browser functional module 51, a sender and receiver control functional module 52, an interpreter functional module 53, a class library functional module 54, an application functional module 55, and a program control functional module 56.

The CPU 45 implements the web browser functional module 51 by reading and executing the web browser program WP from the memory 44 shown in FIG. 4.

The CPU 45 implements the sender and receiver control functional module 52 by reading and executing the sender and receiver control program TP from the memory 44.

The CPU 45 implements the interpreter functional module 53 by reading and executing the interpreter INT from the memory 44.

The CPU 45 implements the class library functional module 54 by reading and executing the class library CL from the memory 44.

The CPU 45 implements the application functional module 55 by reading and executing the application program AP from the memory 44.

The CPU 45 implements the program control functional module 56 by reading and executing a program control program PCP from the memory 44.

The web browser functional module 51 is a program having functions of browsing web pages and downloading a predetermined program by accessing the content server apparatus 12 via the network 9.

The sender and receiver control functional module 52 is a program for controlling transmission and reception of electronic mails (so-called electronic mail software).

The interpreter functional module 53 is software for sequentially converting source code constituting a program into an executable form of object code, and executing the program.

That is, the interpreter functional module 53 is an environment for implementing the application functional module 55. In a so-called java (R) environment when a Java (R) program is executed, Java (R) VM (Virtual Machine) corresponds to the interpreter functional module 53.

The class library functional module 54 is obtained by converting a program having a specific function into a part as one “class” using an object-oriented programming language and combining a plurality of classes into one file. The class library functional module 54 is an API (Application Programming Interface) for the application functional module 55.

In the object-oriented language, an abstraction of a group of objects having common attributes and methods (procedures) is referred to as a “class.” Since such a “class” can be used as a part of a program, labor of programming can be lessened by collecting general-purpose classes used frequently in a class library.

For example, Personal Profile MIDP (Mobile Information Device Profile) is used for the class library functional module 54. MIDP is a profile for J2ME (Java (R) 2 Micro Edition)/CLDC (Connected Limited Device Configuration). MIDP is a specification for a Java (R) execution environment defined for portable terminals such as portable telephones and the like. MIDP includes information such as a user interface, a class library, and the like for portable terminals. For example, when the terminal apparatus 14_1 uses a Java (R) application, the library defined by this profile needs to be prepared in addition to J2ME/CLDC.

A data extracting unit 61, a data creating unit 62, a process control unit 63, a transport API 64, and a GUI (Graphic User Interface) control unit 65 are provided in the library of the class library functional module 54.

The data extracting unit 61 has functions of extracting necessary information from a received electronic mail supplied from the sender and receiver control functional module 52 when the electronic mail has a predetermined format to be described later, and decoding the obtained information.

The data creating unit 62 encodes information necessary for the execution of a program for transmission by electronic mail, and adapts the encoded information to the above-mentioned predetermined format.

The process control unit 63 has a function of managing a process performed by the application functional module 55. In other words, the process control unit 63 can manage a plurality of processes performed by the identical application functional module 55.

The transport API 64 controls transmission and reception of messages by the sender and receiver control functional module 52.

The GUI control unit 65 controls display of a predetermined GUI screen on the liquid crystal display 27 on the basis of a process performed by the application functional module 55.

The program control functional module 56 has a function of downloading an application program on the basis of link information of the application program. The information is added to a received message. The program control functional module 56 has a function of checking validity of a file of the downloaded application program.

The memory 44 shown in FIG. 4 stores data generated by processes performed by the application functional module 55 and information on a history of processes performed by the application functional module 55, as well as data on a process made permanent by a process of the process control functional module 63 and the application program downloaded by the program control functional module 56.

The application functional module 55 is loaded from the memory 44 by control of the process control unit 63 on the basis of an operating input by a user or a received message, and is executed on the interpreter functional module 53.

The format of an electronic mail EM transmitted or received by the terminal apparatus 14_1 will be described in the following.

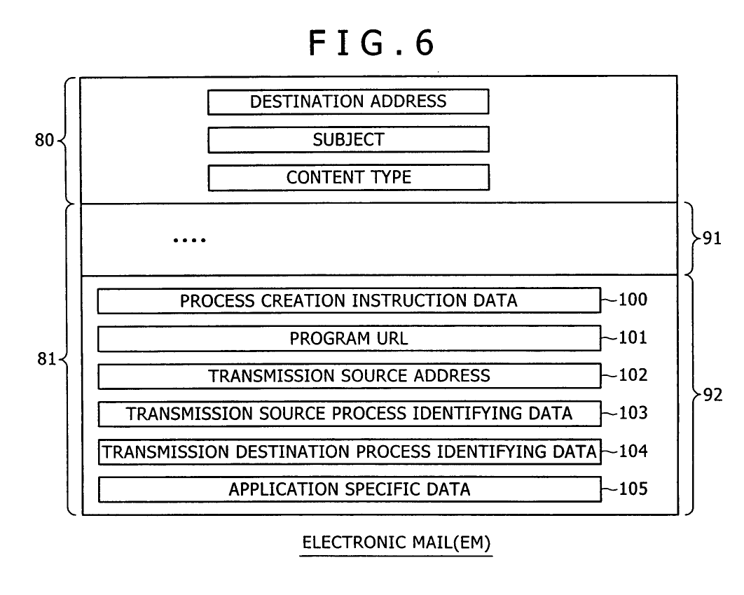

FIG. 6 is a diagram of assistance in explaining the format of an electronic mail EM transmitted or received by the terminal apparatus 14_1.

As shown in FIG. 6, the electronic mail EM includes a header 80 and a body 81.

In the header 80, a destination address, a title (subject), a content type, and the like are described.

When the electronic mail EM is transmitted or received, a plurality of pieces of application data and picture files can be attached to the electronic mail EM. A multipart media type, or a media type combining a plurality of attached files, is used in such a case. The multipart media type is declared in the content type.

When the multipart media type is declared in the content type, the body 81 includes a plurality of parts corresponding to attached files and mail bodies.

The body 81 includes a readable description area 91 and a control description area 92.

Character data readable by the user receiving the electronic mail EM is described in the readable description area 91.

Described in the control description area 92 is information indicating version information of the format of the electronic mail EM and a protocol type, as well as process creation instruction data 100, a program URL 101, a transmission source address 102, transmission source process identifying data 103, transmission destination process identifying data 104, and application specific data 105.

The process creation instruction data 100 is information indicating whether a terminal apparatus that receives the electronic mail EM needs to create a new process. When the process creation instruction data 100 is “1,” the process creation instruction data 100 indicates that a new process needs to be created. When the process creation instruction data 100 is “0,” the process creation instruction data 100 indicates that because the electronic mail EM is related to an already existing process, a new process does not need to be created.

The program URL 101 is link information used to download a program. The program URL 101 is for example used as data for identifying the application program AP.

The transmission source process identifying data 103 is an identifier for identifying a process for a terminal apparatus that transmits the electronic mail EM to operate using information sent and received by the electronic mail EM. The transmission destination process identifying data 104 is an identifier for identifying a process for a terminal apparatus that operates using the information sent and received by the electronic mail EM. These pieces of identifying data are generated in advance and described in the electronic mail EM by the terminal apparatus that transmits the electronic mail EM.

The application specific data 105 is data used by the application functional module 55 shown in FIG. 5. The application specific data 105 can be set arbitrarily by the application functional module 55.

When the terminal apparatus 14_1 receives the electronic mail EM shown in FIG. 6, for example, the program control functional module 56 shown in FIG. 5 checks on the basis of the program URL 101 whether an application program specified by the electronic mail EM is downloaded to the terminal apparatus 14_1 and whether the downloaded application program has the same version as the application program specified by the electronic mail EM. As required, the application program specified by the message is downloaded from the content server apparatus 12.

Specifically, an application description file related to the application program specified by the electronic mail EM is stored at a URL specified by the program URL 101. The program control functional module 56 downloads the application description file to determine whether the corresponding application program is installed in the terminal apparatus 14_1 and whether the installed application program has the same version as the application program specified by the electronic mail EM. The application description file is referred to as an ADF (Application Descriptor File) or a JAD (Java (R) Application Descriptor) file when the application is described in Java (R), for example.

When the corresponding application program is not installed in the terminal apparatus 14_1 or when the installed application program does not have the same version as the application program specified by the electronic mail EM, the application functional module 55 downloads the application program from an address of a location where the application program is stored. The address is described in the application description file.

In this case, the application description file such as the ADF, the JAD, or the like is first downloaded to then determine whether the corresponding application program is installed in the terminal apparatus 14_1 and whether the installed application program has the same version as the application program specified by the electronic mail EM. However, a method of determining whether the corresponding application program is installed in the terminal apparatus 14_1 and whether the installed application program has the same version as the application program specified by the electronic mail EM may be a method other than the method using the application description file. A method for obtaining information on the address of the location where the application program is stored, a download procedure, and the like may be methods other than those described above.

Since it is detected on the basis of data extracted by the data extracting unit 61 shown in FIG. 5 that “I” is described as the process creation instruction data 100 shown in FIG. 6, the application functional module 55 shown in FIG. 5 is started and thus a new process is created by the process of the program control functional module 56.

The application functional module 55 displays necessary information on the liquid crystal display 27 via the LCD control circuit 34 shown in FIG. 3 by the process of the GUI control unit 65. Receiving an operating input by a user via the operating input control circuit 39, the application functional module 55 generates a return electronic mail by the process of the data creating unit 62. The application functional module 55 transmits the return electronic mail to an address indicated by the transmission source address 102 shown in FIG. 6 via the network 9 shown in FIG. 1 by the process of the sender and receiver control functional module 52.

The terminal apparatuses 14_2 and 14_3 have the same configuration and functions as the above-described terminal apparatus 14_1.

An example of operation of the communication system 1 will be described in the following.

### FIRST OPERATION EXAMPLE

In the operation example, description will be made of an example of operation of the terminal apparatus 14_1 when the terminal apparatus 14_1 passes the automatic ticket gate 18_1 installed in a train station as shown in FIG. 1.

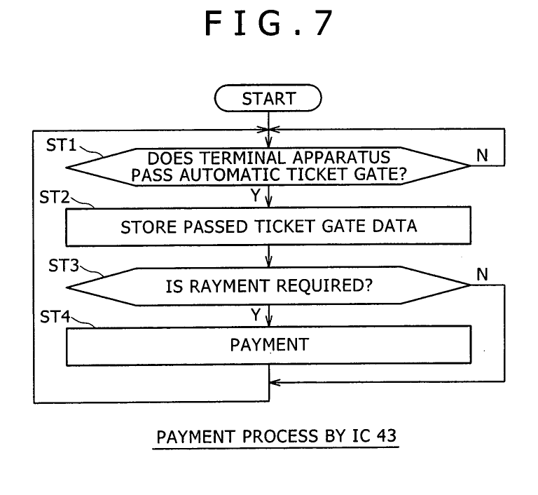

FIG. 7 is a flowchart of assistance in explaining the operation example.

Step ST1:

The IC 43 shown in FIG. 3 monitors to check whether the terminal apparatus 14_1 passes an automatic ticket gate on the basis of a signal received by the antenna 42. When the IC 43 determines that the terminal apparatus 14_1 passes the automatic ticket gate, the process proceeds to step ST2. Otherwise, the IC 43 continues monitoring.

Step ST2:

The IC 43 stores passed ticket gate data included in the signal received by the antenna 42.

The passed ticket gate data for example indicates identifying data of the automatic ticket gate 18_1 passed by the user.

Step ST3:

The IC 43 determines whether a payment is required with the passage through the ticket gate. When the IC 43 determines that a payment is required, the process proceeds to step ST4. Otherwise, the process returns to step ST1.

Step ST4:

The IC 43 communicates with the automatic ticket gate 18_1 to perform a payment process with the passage through the ticket gate.

### SECOND OPERATION EXAMPLE

An example of operation when the user of the terminal apparatus 14_1 inquires present positions of the users of the terminal apparatuses 14_2 and 14_3 will be described in the following.

Incidentally, suppose that before the example of operation is started, the users of the terminal apparatuses 14_1, 14_2, and 14_3 shown in FIG. 1 made an appointment to meet by call, exchange of electronic mails, or the like.

FIG. 8 is a flowchart of assistance in explaining the operation example.

Step ST11:

Operating the operating keys 28 and the jog dial 30 of the terminal apparatus 14_1 shown in FIG. 2 and FIG. 3, the user inputs an instruction to inquire the present positions of the other users.

The operating input control circuit 39 shown in FIG. 3 outputs an operating signal corresponding to the above operation to the CPU 45.

Step ST12:

On the basis of the operating signal input in step ST11, the CPU 45 of the terminal apparatus 14_1 starts the application functional module 55 shown in FIG. 5.

Step ST13:

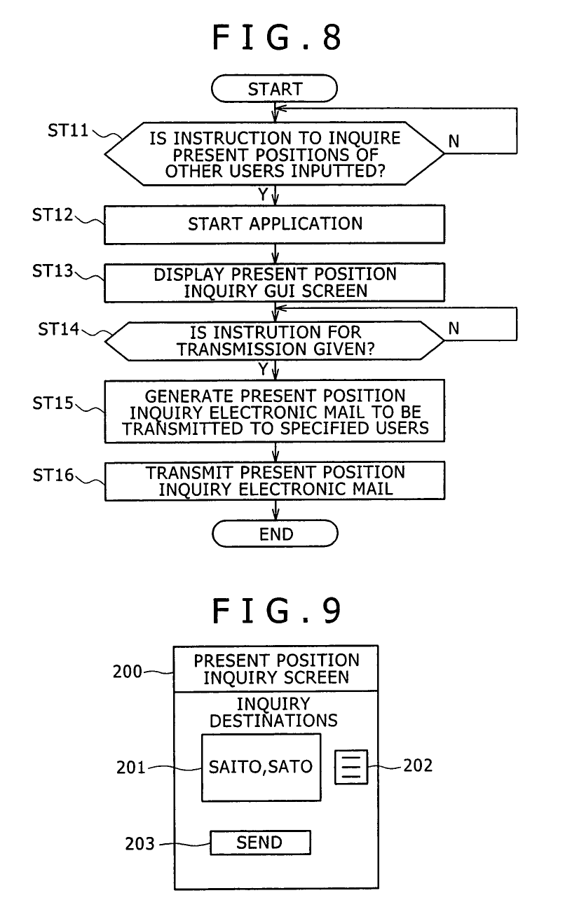

Under control of the application functional module 55, the GUI control unit 65 of the class library functional module 54 shown in FIG. 5 displays a present position inquiry GUI screen 200 shown in FIG. 9 on the liquid crystal display 27 via the LCD control circuit 34.

As shown in FIG. 9, the present position inquiry GUI screen 200 for example has an inquiry destination input section 201, an address book icon 202, and a sender icon 203.

The user specifies the address book icon 202 on the present position inquiry GUI screen 200 by the jog dial 30 shown in FIG. 3, for example, to display an address book section (not shown in the figure) on the liquid crystal display 27.

Then, the user specifies preregistered user names (“Saito” and “Sato” in FIG. 9) of the terminal apparatuses 14_2 and 14_3 as inquiry destinations in the address book section.

Thereby the names of “Saito” and “Sato” are displayed within the inquiry destination input section 201.

Step ST14:

When the names of all the users whose present positions are to be inquired are displayed, the user of the terminal apparatus 14_1 specifies the sender icon 203 on the present position inquiry GUI screen 200.

When the application functional module 55 determines that the sender icon 203 is specified, the process proceeds to step ST15.

Step ST15:

Under control of the application functional module 55, the data creating unit 62 shown in FIG. 5 generates present position inquiry electronic mails in the format shown in FIG. 6 with addresses of the users specified in step ST13 as destinations of the present position inquiries set as destination addresses.

Step ST16:

Under control of the application functional module 55, the sender and receiver control functional module 52 shown in FIG. 5 transmits the present position inquiry electronic mails generated in step ST15.

The present position inquiry electronic mails are modulated by the modulating and demodulating circuit 38 shown in FIG. 3, converted into an analog signal by the sender and receiver circuit 37, and then transmitted to the network 9 via the antenna 25.

The present position inquiry electronic mails are then transmitted to the terminal apparatuses 14_2 and 14_3 via the mail server apparatus 10.

### THIRD OPERATION EXAMPLE

An example of operation performed by the terminal apparatus 14_2 receiving the present position inquiry electronic mail transmitted by the procedure shown in FIG. 8 will be described in the following.

An example of operation of the terminal apparatus 14_3 in this case is the same as the example of operation of the terminal apparatus 14_2 to be described below.

The example of operation in the case of the terminal apparatus 14_2 will be described in the following.

FIG. 10 is a flowchart of assistance in explaining the operation example.

Step ST21:

The sender and receiver control functional module 52 shown in FIG. 5 of the terminal apparatus 14_2 determines whether the above-described present position inquiry electronic mail is received. When the sender and receiver control functional module 52 of the terminal apparatus 14_2 determines that the above-described present position inquiry electronic mail is received, the process proceeds to step ST22.

Step ST22:

On the basis of the program URL 101 shown in FIG. 6 within the received present position inquiry electronic mail, the program control functional module 56 shown in FIG. 5 of the terminal apparatus 14_2 checks whether the application program specified by the present position inquiry electronic mail is downloaded to the terminal apparatus 14_2 and whether the version of the downloaded application program matches that of the application program specified by the present position inquiry electronic mail.

When the program control functional module 56 determines that the specified application program is downloaded and that the version of the downloaded application program matches that of the specified application program, the process proceeds to step ST24. Otherwise, the process proceeds to step ST23.

Step ST23:

The program control functional module 56 accesses the content server apparatus 12 shown in FIG. 1 on the basis of the program URL 101 shown in FIG. 6 within the received present position inquiry electronic mail, downloads the application program AP, and then writes the application program AP to the memory 44 shown in FIG. 4.

Step ST24:

The process control unit 63 reads and executes the application program AP from the memory 44 and thereby starts the application functional module 55.

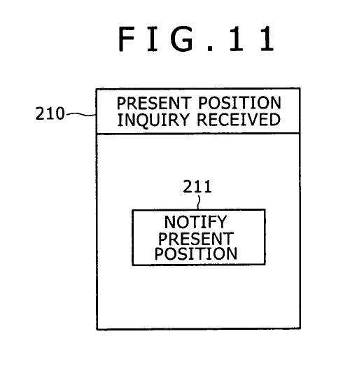

Under control of the application functional module 55, the GUI control unit 65 displays a GUI screen 210 shown in FIG. 11 on the liquid crystal display 27 of the terminal apparatus 14_2 via the LCD control circuit 34 shown in FIG. 3.

Step ST25:

The application functional module 55 determines whether a present position notification instruction icon 211 is specified on the GUI screen 210 shown in FIG. 11 on the basis of an operating signal from the operating input control circuit 39. When the application functional module 55 determines that the present position notification instruction icon 211 is specified, the process proceeds to step ST26.

Step ST26:

The application functional module 55 outputs a request to the IC 43 to input passed ticket gate data as present position data from the IC 43.

The passed ticket gate data represents identifying data of the automatic ticket gate 18_2 passed by the terminal apparatus 14_2 or position data.

Step ST27:

Under control of the application functional module 55, the data creating unit 62 shown in FIG. 5 of the terminal apparatus 14_2 generates a present position reply electronic mail in the form shown in FIG. 6. The present position reply electronic mail includes the passed ticket gate data input in step ST25 as the application specific data 105 shown in FIG. 6 and includes the transmission source address 102 of the received present position inquiry electronic mail as a destination address.

Step ST28:

Under control of the application functional module 55, the sender and receiver control functional module 52 shown in FIG. 5 of the terminal apparatus 14_2 transmits the present position reply electronic mail generated in step ST27.

The present position reply electronic mail is modulated by the modulating and demodulating circuit 38 shown in FIG. 3 of the terminal apparatus 14_2, converted into an analog signal by the sender and receiver circuit 37, and then transmitted to the network 9 via the antenna 25.

### FOURTH OPERATION EXAMPLE

An example of operation performed by the terminal apparatus 14_1 receiving the present position reply electronic mail transmitted by the procedure shown in FIG. 10 will be described in the following.

FIG. 12 is a flowchart of assistance in explaining the operation example.

Step ST31:

The sender and receiver control functional module 52 shown in FIG. 5 of the terminal apparatus 14_1 determines whether the above-described present position reply electronic mail is received. When the sender and receiver control functional module 52 determines that the present position reply electronic mail is received, the process proceeds to step ST32.

Step ST32:

The data extracting unit 61 shown in FIG. 5 of the terminal apparatus 14_1 extracts a transmission source address 102 as shown in FIG. 6 and the present position data within the application specific data 105 from the present position reply electronic mail received in step ST31.

Then, the data extracting unit 61 writes the extracted transmission source address 102 and the extracted present position data to the memory 44 shown in FIG. 3 in association with each other.

Step ST33:

The application functional module 55 determines whether present position reply electronic mails are received from all destination addresses specified as destinations of the present position inquiry electronic mail in step ST13 shown in FIG. 8. When the application functional module 55 determines that the present position reply electronic mails are received from all the destination addresses, the process proceeds to step ST34.

In the first embodiment, when the application functional module 55 determines that present position reply electronic mails are received from the terminal apparatuses 14_2 and 14_3 shown in FIG. 1, the process proceeds to step ST34.

Step ST34:

The application functional module 55 generates meeting place data and latest arrival time data by a predetermined algorithm on the basis of all the pieces of present position data stored in the memory 44 in step ST32 and present position data of the terminal apparatus 14_1 read from the IC 43 of the terminal apparatus 14_1.

Under control of the application functional module 55, the GUI control unit 65 displays a GUI screen 220 shown in FIG. 13 on the liquid crystal display 27 via the LCD control circuit 34 shown in FIG. 3. The screen shows the meeting place data and the latest arrival time data generated as described above.

As shown in FIG. 13, the GUI screen 220 displays a meeting place display section 221, a latest arrival time display section 222, and a sender icon 223.

The generated meeting place data is displayed in the meeting place display section 221. The generated latest arrival time data is displayed in the latest arrival time display section 222.

The latest arrival time data indicates an arrival time of a user who will arrive at the meeting place the latest of a plurality of users, for example.

In the example shown in FIG. 13, “Shinjuku” is displayed in the meeting place display section 221, and “PM:08:30” is displayed in the latest arrival time display section 222.

Incidentally, the application functional module 55 may display information related to the meeting place displayed in the meeting place display section 221, for example information on a facility or a store in the vicinity of the meeting place on the GUI screen 220 shown in FIG. 13.

At this time, the application functional module 55 may access another server apparatus via the network 9 to obtain information related to the meeting place.

Step ST35:

After the user of the terminal apparatus 14_1 checks the meeting place display section 221 and the latest arrival time display section 222 on the GUI screen 220 shown in FIG. 13, the user specifies the sender icon 223 using the jog dial 30 or the like.

When the application functional module 55 determines that the sender icon 223 is specified, the process proceeds to step ST36.

Step ST36:

Under control of the application functional module 55, the data creating unit 62 shown in FIG. 5 of the terminal apparatus 14_1 generates a meeting place notification electronic mail including the meeting place data and the latest arrival time data generated in step ST34 as application specific data 105 shown in FIG. 6.

At this time, the addresses specified in the inquiry destination input section 201 of the present position inquiry GUI screen 200 shown in FIG. 9 are set as destination addresses of the meeting place notification electronic mail.

Step ST37:

Under control of the application functional module 55, the sender and receiver control functional module 52 shown in FIG. 5 of the terminal apparatus 14_1 transmits the meeting place notification electronic mail generated in step ST36.

The meeting place notification electronic mail is modulated by the modulating and demodulating circuit 38 shown in FIG. 3 of the terminal apparatus 14_1, converted into an analog signal by the sender and receiver circuit 37, and then transmitted to the network 9 via the antenna 25.

An example of the process in step ST34 shown in FIG. 12, that is, the process of generating meeting place data and latest arrival time data will be described concretely in the following.

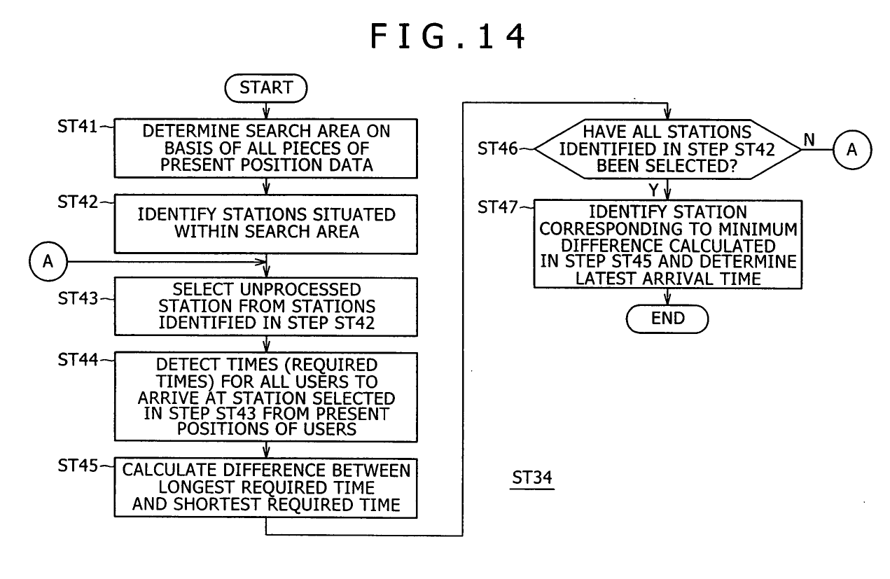

FIG. 14 is a flowchart of assistance in explaining the process.

Step ST41:

The application functional module 55 determines a search area on the basis of all the pieces of present position data stored in the memory 44 in step ST32 shown in FIG. 12 and the present position data of the terminal apparatus 14_1 read from the IC 43 of the terminal apparatus 14_1.

For example, the application functional module 55 determines an area that includes all present positions indicated by the present position data and is minimized under a predetermined condition as a search area.

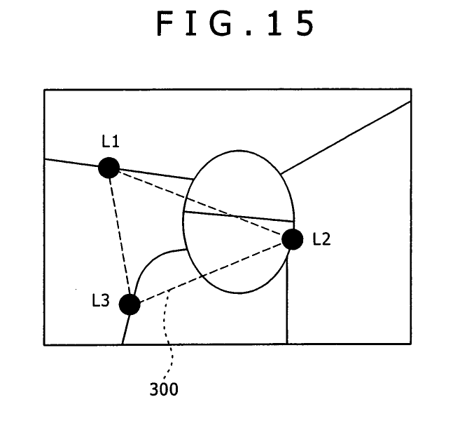

For example, when the present position data of the terminal apparatuses 14_1, 14_2, and 14_3 indicates present positions L1, L2, and L3 on a map as shown in FIG. 15, the application functional module 55 determines a triangular area 300 having the present positions L1, L2, and L3 as vertexes as a search area in a plurality of predetermined search areas.

Step ST42:

The application functional module 55 identifies stations situated within the search area determined in step ST41.

Step ST43:

The application functional module 55 selects an unprocessed station from the stations identified in step ST42.

Step ST44:

The application functional module 55 detects times (required times) for all the users who are to meet to arrive at the station selected in step ST43 from the present positions (stations) of the users.

At this time, the application functional module 55 may detect the required times on the basis of boarding times assumed from a present time and train schedule data, or may detect the required times using only retained data on traveling times for travel between stations.

Also, at this time, the application functional module 55 may for example transmit a request specifying the present time, the stations as the present positions, and the station as the meeting place to a server apparatus not shown in the figure, and receive data indicating the required times from the server apparatus.

Step ST45:

The application functional module 55 calculates a difference between a longest required time and a shortest required time of the required times detected for the users in step ST44.

Step ST46:

The application functional module 55 determines whether all the stations identified in step ST42 have been selected in step ST43. When the application functional module 55 determines that all the stations identified in step ST42 have been selected in step ST43, the process proceeds to step ST47. Otherwise the process returns to step ST43.

Step ST47:

The application functional module 55 identifies a station corresponding to a minimum difference of the differences calculated in step ST45 for all the stations identified in step ST42.

Then, the application functional module 55 generates meeting place data indicating the identified station.

Also, the application functional module 55 calculates the arrival time of the latest user (latest arrival time data) on the basis of the longest required time of the required times required to arrive at the station.

As described above, according to the communication system 1, by only giving an instruction for present position inquiry in step ST11 shown in FIG. 8, the user of the terminal apparatus 14_1 can automatically obtain the GUI screen 220 showing the meeting place search result shown in FIG. 13, and obtain the meeting place and the latest arrival time on the basis of the GUI screen 220.

Further, by only specifying the sender icon 223 on the GUI screen 220 shown in FIG. 13, the user of the terminal apparatus 14_1 can notify the meeting place and the latest arrival time obtained as described above to the users of the terminal apparatuses 14_2 and 14_3.

It is therefore possible to reduce a burden on the user who determines the meeting place.

In addition, the communication system 1 enables an appropriate place that reduces the difference between the required times required to go to the meeting place from the present positions of the users of the terminal apparatuses 14_1, 14_2, and 14_3 to be automatically retrieved as the meeting place.

### Second Embodiment

The second embodiment is different from the first embodiment in step ST34 in FIG. 12 performed by the application functional module 55.

The second embodiment uses a terminal apparatus 14_4 (not shown) in addition to terminal apparatuses 14_1 to 14_3.

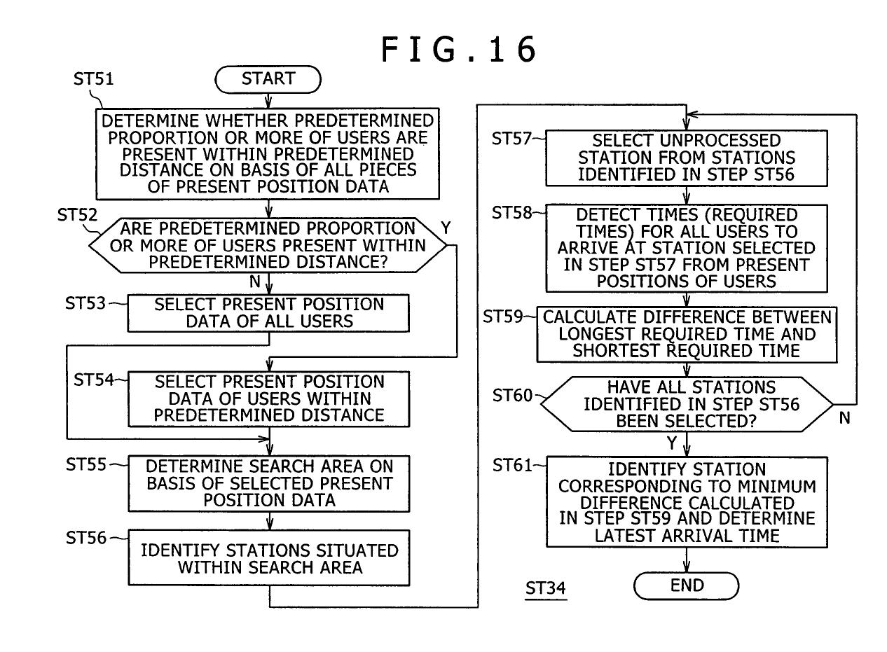

FIG. 16 is a flowchart of step ST34 in FIG. 12 performed by the application functional module 55 in the second embodiment.

Step ST51:

The application functional module 55 determines whether a predetermined proportion or more of the terminal apparatuses are present within a predetermined distance on the basis of all the pieces of present position data stored in the memory 44 in step ST32 shown in FIG. 12 and the present position data of the terminal apparatus 14_1 read from the IC 43 of the terminal apparatus 14_1.

For example, the application functional module 55 determines whether ¾ of the terminal apparatuses (three terminal apparatuses) or more are situated within a radius of 10 km on the basis of the present position data of the terminal apparatuses 14_1 to 14_4. At this time, the application functional module 55 makes the above determination on the basis of table data stored in the memory 44 shown in FIG. 3. The data represents latitude data and longitude data of the present positions indicated by the present position data.

Incidentally, the application functional module 55 may transmit the present position data to a predetermined server apparatus to have the server apparatus make the above determination, and receive a result of the determination from the server apparatus.

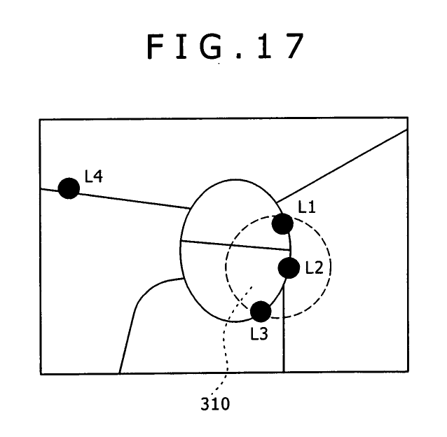

As shown in FIG. 17, for example, when the terminal apparatuses 14_1 to 14_4 are situated at present positions L1 to L4, and when the present positions L1 to L3 are within the radius of 10 km and the present position L4 is out of the radius of 10 km, the application functional module 55 determines that ¾ or more of the terminal apparatuses are present within the radius of 10 km.

Step ST52:

When the application functional module 55 determines in step ST51 that the predetermined proportion or more of the terminal apparatuses are present within the predetermined distance, the process proceeds to step ST54. Otherwise, the process proceeds to step ST53.

Step ST53:

The application functional module 55 selects the present position data of all the terminal apparatuses.

Step ST54:

The application functional module 55 selects only the present position data of the terminal apparatuses determined to be situated within the predetermined distance in step ST51.

Step ST55:

The application functional module 55 determines a search area by the same method as step ST41 shown in FIG. 14 on the basis of the present position data selected in step ST53 or step ST54.

Steps ST56 to ST61:

Steps ST56 to ST61 are basically the same as steps ST42 to ST47 shown in FIG. 14.

As described above, according to the communication system 1, when the predetermined proportion or more of the terminal apparatuses are present within the predetermined distance, the meeting place is determined on the basis of only the present position data of these terminal apparatuses situated within the predetermined distance. It is therefore possible to reduce a burden of travel of the predetermined proportion or more of the users.

### Third Embodiment

The third embodiment is different from the first embodiment in step ST34 in FIG. 12 performed by the application functional module 55.

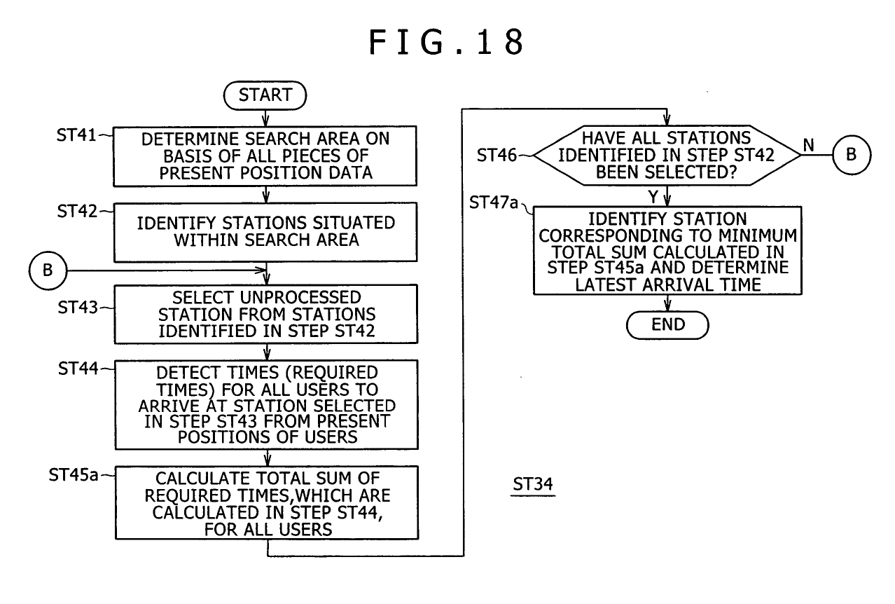

FIG. 18 is a flowchart of step ST34 in FIG. 12 performed by the application functional module 55 in the third embodiment.

In FIG. 18, steps ST41, ST42, ST43, ST44, and ST46 identified by the same references as in FIG. 14 are the same as the steps described in the first embodiment.

In the third embodiment, steps ST45a and ST47a shown in FIG. 18 are different from steps ST45 and ST47 shown in FIG. 14.

Steps ST45a and ST47a shown in FIG. 18 will be described in the following.

Step ST45a:

The application functional module 55 shown in FIG. 5 calculates a total sum (cumulative sum) of the required times for the users. The times are detected in step ST44 described in the first embodiment.

Step ST47a:

The application functional module 55 identifies a station corresponding to a minimum total sum of total sums calculated in step ST45a for all the stations identified in step ST42 described in the first embodiment.

Then, the application functional module 55 generates meeting place data indicating the identified station.

Also, the application functional module 55 calculates the arrival time of the latest user (latest arrival time data) on the basis of the longest required time of the required times required to arrive at the station.

As described above, according to the communication system 1, a place that minimizes a total sum of times required to arrive at a meeting place from present positions of users of a plurality of terminal apparatuses is retrieved as the meeting place. It is therefore possible to reduce a total traveling time of the plurality of users.

### Fourth Embodiment

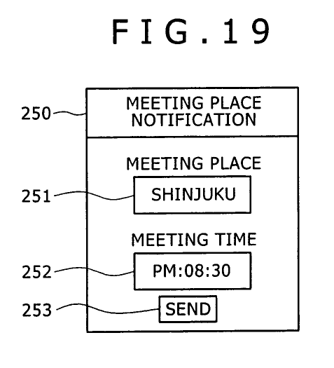

In the foregoing first embodiment, a case where the application functional module 55 automatically transmits a meeting place notification electronic mail when the sender icon 223 is specified on the GUI screen 220 of the meeting place search result shown in FIG. 13 is illustrated, while in the fourth embodiment, a GUI screen 250 of meeting place notification shown in FIG. 19 is displayed when the sender icon 223 is specified.

The GUI screen 250 displays a meeting place display section 251, a meeting time display section 252, and a sender icon 253.

Viewing the GUI screen 250, the user can specify a new meeting place using the meeting place display section 251, and specify a new meeting time using the meeting time display section 252.

That is, the user himself/herself specifies the meeting place and the meeting time referring to contents displayed on the GUI screen 220 shown in FIG. 13.

After completing the specification, the user specifies the sender icon 253 to transmit a meeting place notification electronic mail indicating the meeting place and the meeting time specified as described above.

### Fifth Embodiment

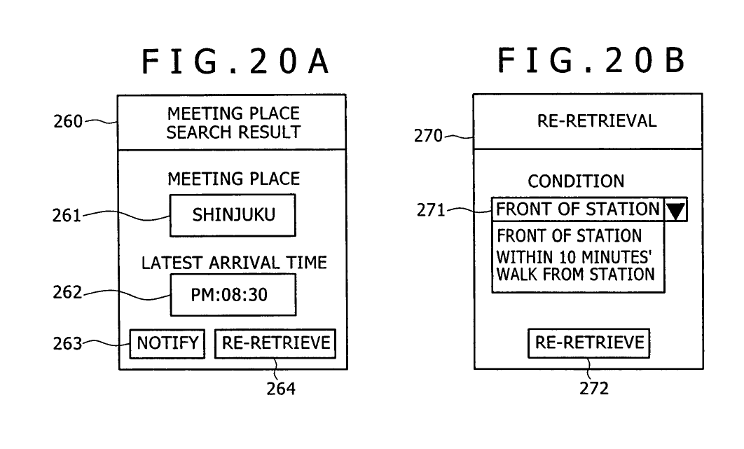

In the fifth embodiment, a GUI screen 260 shown in FIG. 20A is displayed in place of the GUI screen 220 shown in FIG. 13 described in the first embodiment.

The GUI screen 260 displays a meeting place display section 261, a latest arrival time display section 262, and a sender icon 263 as in FIG. 13, and additionally displays a re-retrieval icon 264.

The meeting place display section 261, the latest arrival time display section 262, and the sender icon 263 are the same as the meeting place display section 221, the latest arrival time display section 222, and the sender icon 223 described in the first embodiment.

When the user specifies the re-retrieval icon 264 on the GUI screen 260, a GUI screen 270 for re-retrieval as shown in FIG. 20B is displayed.

The GUI screen 270 displays a condition input section 271 for retrieving a condition of a meeting place as shown in FIG. 20B. The user specifies or inputs a condition by operating the condition input section 271.

On the basis of the condition input by using the condition input section 271, the application functional module 55 for example selects stations matching the condition from the stations identified in step ST42 shown in FIG. 14, and re-retrieves a station (meeting place) that minimizes the difference calculated in step ST45 from the selected stations.

Then, the application functional module 55 displays the re-retrieved meeting place in the same manner as the GUI screen 220 shown in FIG. 13, for example.

Incidentally, the condition may for example be input before step ST42 shown in FIG. 14 so that the stations matching the condition are identified in step ST42.

### Sixth Embodiment

In the foregoing embodiments, a case is illustrated where present position data, which is generated by the IC 43 shown in FIG. 3 of the terminal apparatuses 14_1 to 14_3, indicating passed ticket gates is transmitted as present position data of the terminal apparatuses 14_1 to 14_3 to the terminal apparatus that determines a meeting place.

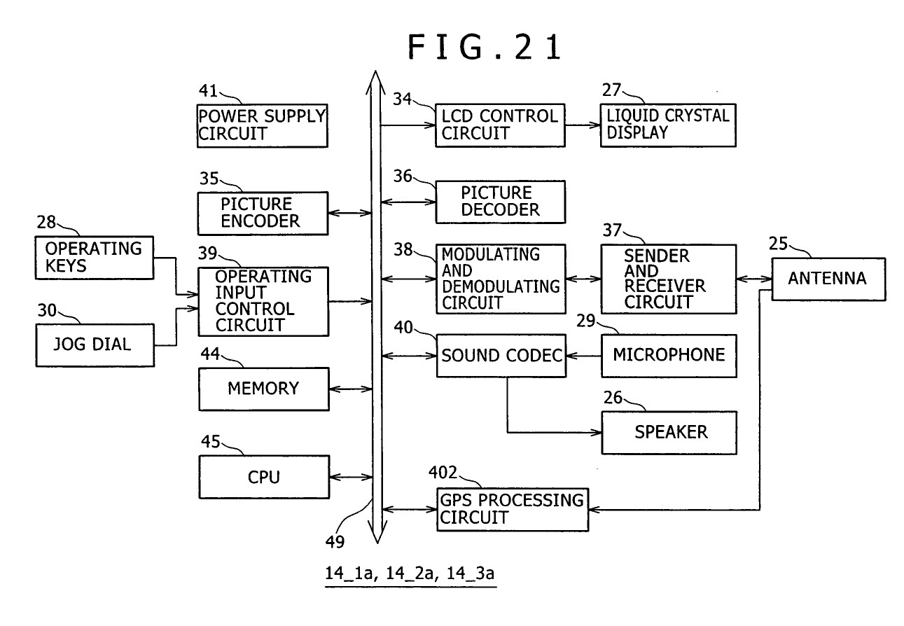

As shown in FIG. 21, terminal apparatuses 14_1a to 14_3a in the sixth embodiment have a GPS processing circuit 402 in place of the IC 43 and the antenna 42 shown in FIG. 3.

In FIG. 21, components identified by the same reference numerals as in FIG. 3 are the same as described in the first embodiment.

The GPS processing circuit 402 generates present position data indicating a position of the terminal apparatus including the GPS processing circuit 402 on the basis of a signal received from a satellite by an antenna 25.

In the sixth embodiment, the application functional module 55 shown in FIG. 5 implemented by a CPU 45 generates meeting place data and the like by the method described in the first to fifth embodiments using the present position data obtained by the GPS processing circuit 402 as the present position data described in the first embodiment.

In this case, assuming that each user travels by car, for example, the GPS processing circuit 402 calculates a time required for each user to arrive at a meeting place on the basis of road map data.

At this time, the application functional module 55 may refer to traffic congestion data obtained from a server apparatus not shown in the figure to calculate the required time in consideration of traffic congestion.

Incidentally, at least one of the terminal apparatuses 14_1 to 14_3 may have both the IC 43 and the antenna 42 shown in FIG. 3 and the GPS processing circuit 402 shown in FIG. 21 so that the user may select which to use.

Further, the application functional module 55 of a terminal apparatus that determines a meeting place may distinguish users taking a train from users taking a car, calculate times required to arrive by train for the users taking a train and calculate times required to arrive by car for the users taking a car on the basis of present position data obtained from terminal apparatuses of the users, and generate meeting place data on the basis of the calculated required times.

The present invention is not limited to the foregoing embodiments.

For example, in the foregoing embodiments, a case is illustrated where the terminal apparatuses 14_1 to 14_3 access the content server apparatus 12 and download an application program when the terminal apparatuses 14_1 to 14_3 do not have the application program to be started by an electronic mail received by the terminal apparatuses 14_1 to 14_3. However, the application program may be included within the electronic mail.

Further, in the foregoing embodiments, the terminal apparatuses 14_1 to 14_3, which are portable telephones, are illustrated as the computer according to the present invention. However, the computer according to the present invention may be a PDA (Personal Digital Assistant), a portable type personal computer, or the like.

Further, a user as a transmission source may be able to add some message for a user as a transmission destination on a GUI screen in each of the foregoing embodiments.

The present invention is applicable to data communication systems.

While preferred embodiments of the invention have been described using specific terms, such description is for illustrative purposes only, and it is to be understood that changes and variations may be made without departing from the spirit or scope of the following claims.

1. A program for making a computer perform, comprising:
a first step of determining a place where users of a plurality of computers are to meet on a basis of index data serving as indexes for identifying positions of said plurality of computers; and
a second step of transmitting data indicating the place determined in said first step to said computers.

2. The program as claimed in claim 1, wherein in said first step, required time data indicating times required for arrival of the users of said plurality of computers is generated on a basis of said index data, and said place is determined on a basis of said required time data.

3. The program as claimed in claim 2, wherein in said first step, said place where a difference in said required time indicated by said required time data between the users of said plurality of computers satisfies a predetermined criterion is determined.

4. The program as claimed in claim 3, wherein in said first step, said place where said difference satisfies said predetermined criterion is determined among a plurality of predetermined places.

5. The program as claimed in claim 4, wherein said place that minimizes said difference is determined.

6. The program as claimed in claim 2, wherein in said first step, when it is determined on a basis of said index data that a predetermined proportion or more of said plurality of computers are situated within a predetermined distance, said place is determined using said index data corresponding to said computers situated within said predetermined distance and not using said index data corresponding to said computers situated outside said predetermined distance.

7. The program as claimed in claim 2, wherein in said first step, said place that minimizes a total sum of times required for arrival of the users of said plurality of computers on a basis of said index data is determined.

8. The program as claimed in claim 7, wherein in said first step, said place that minimizes said total sum is determined among a plurality of predetermined places.

9. The program as claimed in claim 2, wherein in said first step, an executing circuit included in said computer reads said index data from a memory included in said computer and determines said place on a basis of the read said index data according to said program.

10. The program as claimed in claim 1, further comprising a third step of transmitting, to other said computers, request data requesting said index data of the other said computers, wherein in said first step, the place where the users of said plurality of computers are to meet is determined on a basis of said index data received in response to said request transmitted in said third step.

11. The program as claimed in claim 1, further comprising a fourth step of obtaining index data for identifying a position of the computer executing said program in response to request data received from another said computer, and transmitting the obtained index data to the transmission source of said request data.

12. The program as claimed in claim 1, wherein said index data indicates positions where said computers are used or positions of said computers identified by a GPS (Global Positioning System).

13. The program as claimed in claim 2, further comprising a fifth step of receiving a specification of a purpose for which said users are to meet, wherein in said first step, said place is determined from among a plurality of places matching said purpose specified in said fifth step.

14. The program as claimed in claim 1, wherein said computers are mobile type computers.

15. The program as claimed in claim 1, wherein said computers are portable type terminal apparatuses.

16. A computer comprising: a memory for storing a program; an interface; and an executing circuit; wherein said executing circuit reads and executes said program from said memory, and according to said program, said executing circuit determines a place where users of a plurality of computers are to meet on a basis of index data serving as indexes for identifying positions of said plurality of computers and transmits data indicating the determined place to said computers via said interface.

17. The computer as claimed in claim 16, wherein said executing circuit generates required time data indicating times required for arrival of the users of said plurality of computers on a basis of said index data, and determines said place on a basis of said required time data.

18. The computer as claimed in claim 16, wherein said executing circuit transmits a request to other said computers than the computer executing said program among said plurality of computers via said interface, and determines said place on a basis of said index data received in response to said request from the other computers.

19. The computer as claimed in claim 18, further comprising a tamper-resistant integrated circuit for performing a payment process by performing communication with another apparatus, and generating said index data of said computer executing said program on a basis of a position of said other apparatus identified by the communication, wherein said executing circuit determines said place on a basis of said index data received from said other computers and said index data generated by said integrated circuit.

20. A data processing method performed by a computer, said data processing method comprising:
determining a place where users of a plurality of computers are to meet on a basis of index data serving as indexes for identifying positions of said plurality of computers; and
transmitting data indicating the place determined in said first step to said computers.

21. The data processing method as claimed in claim 20, wherein required time data indicating times required for arrival of the users of said plurality of computers is generated on a basis of said index data, and said place is determined on a basis of said required time data.
